(19) United States
(12) Patent Application Publication
(10) Pub. No.: US 2005/0232832 A1
(43) Pub. Date: Oct. 20, 2005

(54) System and method for preventing and removing mold/mildew from forming in the interior of walls and other areas

(76) Inventor: Harish Kumar, Anthem, AZ (US)

Correspondence Address: WEISS & MOY PC, 4204 NORTH BROWN AVENUE, SCOTTSDALE, AZ, 85251, US

(21) Appl. No.: 10/825,829

(22) Filed: Apr. 16, 2004

(51) Int. Cl. B01J 19/08

(52) U.S. Cl. 422/186.07; 422/186.12

(57) ABSTRACT

A system for preventing mold from forming and for removing exiting mold, mildew, and other bacteria from an interior of walls and other areas has at least one ionizer/air purifier unit for generating ionized air and activated oxygen. Ducting may be coupled to the at least one ionizer/air purifier unit. The ducting is used for transferring the ionized air to the interior of the walls and the other areas in the enclosed area.

### BACKGROUND OF THE INVENTION

1. Field of the Invention

This invention relates to mold removal and, more specifically, to a system and method for preventing mold from forming and for removing exiting mold and mildew from the interior of walls and other areas in new and existing homes.

2. Description of the Prior Art

In many geographical regions of the United States, as well as in other countries, the unwanted growth of mold and mildew is an annoying problem. The rapid growth of mold and mildew on surfaces, such as house walls, is a particularly annoying problem for those who live in hot, humid geographical areas.

Mold can affect the health of people who are exposed to it. People are mainly exposed to mold by breathing spores or other tiny fragments. People can also be exposed through skin contact with mold contaminants (for example, by touching moldy surfaces) and by swallowing it. The type and severity of health effects that mold may produce are usually difficult to predict. The risks can vary greatly from one location to another, over time, and from person to person. There is wide variability in how different people are affected by indoor mold. However, the long term presence of indoor mold growth may eventually become unhealthy for anyone.

Some types of mold can produce chemical compounds called mycotoxins although they do not always do so. Molds that are able to produce toxins are common. In some circumstances, the toxins produced by indoor mold may cause health problems. However, all indoor mold growth is potentially harmful and should be removed promptly, no matter what types of mold is present or whether it can produce toxins.

In order to remove the mold adhered to the walls and furniture in homes, people generally use diluted chlorine bleach to wipe the mold from the walls. Although chlorine bleaching agents have a superior bleaching strength, there are disadvantages including providing discomfort to the user due to the peculiar odor generated by the molecular chlorine as well as concerns regarding the toxic effects of chlorine gas, depending on the method of use. Furthermore, there is the concern that chlorine bleaching agents form environmentally undeniable organic chlorine compounds as by-products.

Another problem with using diluted chlorine bleach is that one generally only uses diluted chlorine bleach to wipe away mold which is visible. Mold which is forming behind the walls or under floor boards cannot be removed by wiping the mold diluted chlorine unless one removes the parts of the wall or floorboards. In order to remove mold, mildew and other bacteria from inside the wall, one must break down part of the wall. This is an extremely time consuming and expensive process.

The above prior art systems and methods describe ways of treating mold which has already formed on walls or other areas of a home or office. The above will not prevent mold from reforming on different areas of the home or office.

Therefore, there is a need to provide an improved system and method for preventing and removing mold, mildew, and other bacteria. The improved system and method of removing mold, mildew, and other bacteria must overcome the problems associated with prior art systems and methods.

### SUMMARY OF THE INVENTION

In accordance with one embodiment of the present invention, it is an object of the present invention to provide an improve system and method for preventing mold, mildew, and other bacteria from forming.

It is another object of the present invention to provide an improved system and method of removing mold, mildew, and other bacteria that has already formed.

It is still another object of the present invention to provide an improve system and method for preventing mold, mildew, and other bacteria from forming and for removing mold, mildew, and other bacteria that has already formed.

### BRIEF DESCRIPTION OF THE EMBODIMENTS

In accordance with one embodiment of the present invention a system for preventing mold from forming and for removing exiting mold, mildew, and other bacteria from an interior of walls and other areas in an enclosed area is disclosed. The system comprises at least one ionizer/air purifier unit for generating ionized air and generating activated oxygen which sanitizes air. Ducting may be coupled to the at least one ionizer/air purifier unit. The ducting is used for transferring the ionized air to the interior of the walls and the other areas in the enclosed area.

In accordance with another embodiment of the present invention, a system for preventing mold from forming and for removing exiting mold, mildew, and other bacteria from an interior of walls and other areas in an enclosed area is disclosed. The system has at least one ionizer/air purifier unit. The ionizer/air purifier unit is used for generating ionized air and activated oxygen and is located internal to the walls. Openings are formed in wall supports to facilitate the air flow in the interior of the walls.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a perspective view of an ionizer/air purifier used in the present invention.

FIG. 2 is a perspective view of one embodiment of the system of the present invention.

FIG. 3 is a perspective view of another embodiment of the system of the present invention.

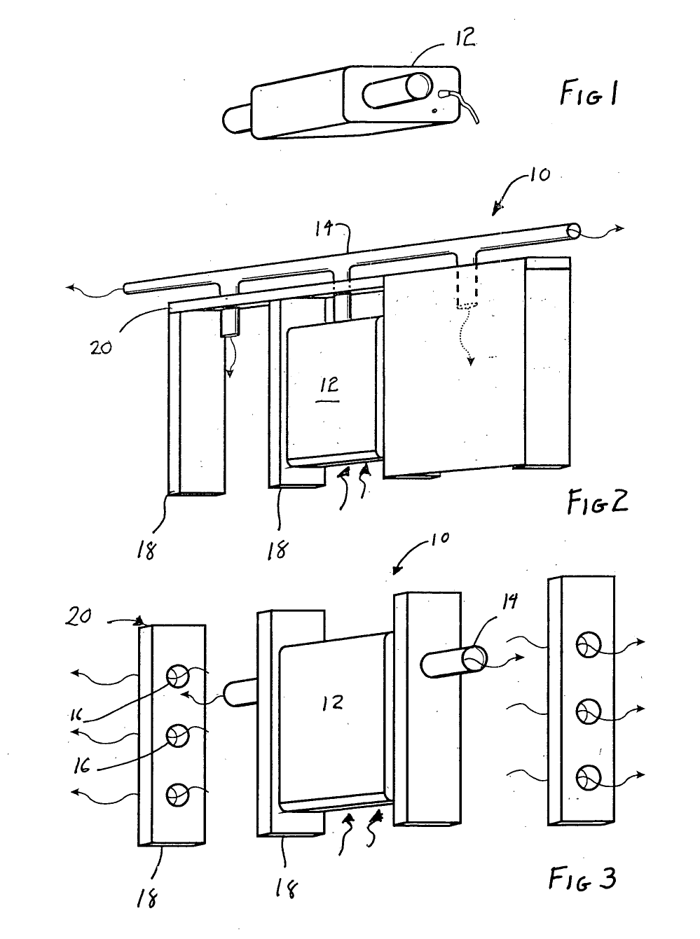

### DETAILED DESCRIPTION OF THE PREFERRED EMBODIMENT

Referring to the Figures, a system for preventing mold from forming and for removing mold that has already formed 10 (hereinafter system 10) is shown. The system 10 may be implement in a new home/office, an existing home/office, or any enclosed space where prevention and/or removal of mold is needed.

The system 10 is comprised of an ionizer/air purifier 12. One or more ionizer/air purifier(s) 12 may be used in the system 10. The number of ionizer/air purifier(s) 12 used will be based on the size of the area to be treated and the power of the ionizer/air purifier(s) 12 to be used. The ionizer/air purifier 12 may be permanently positioned in the enclosed area or may be a portable unit.

The ionizer/air purifier 12 works in the following manner. Virtually all particles in the air have a positive charge. The ionizer/air purifier 12 generates and distributes negative ions which have a negative charge. The negative ions and particles magnetically attract to one another. When there is a high enough concentration of negative ions in the air, they will attract to floating particles in large numbers. This causes the particle to become too heavy to remain airborne. As a result, the particle will fall out of the air, preventing it from being inhaled into the respiratory tract where it can trigger breathing and health problems. Recent studies by the U.S. Dept. of Agriculture have found that ionizing a room led to 52% less dust in the air, and 95% less bacteria in the air (since many of the pollutants found in the air reside on floating dust particles).

The ionizer/air purifier 12 will further perform a purification function. The ionizer/air purifier 12 will generate and distribute activated oxygen. The activated oxygen is used to sanitize the air and to kill any mold, mildew and other bacteria in the interior of the walls and other places in the enclosed area. The ionizer/air purifier 12 will also have a filter system. The filter system will draw in the air to the ionizer/air purifier 12 and run the air through a filtration system within the ionizer/air purifier 12. The filtration system will remove even the smallest particulates from the air. The combination ionization and filtration of the air will offers optimum protection against harmful particles, such as pollen, dust and spores, that are up to 100,000 times finer than a human hair.

The ionizer/air purifier 12 may be positioned in any convenient location in or around the vicinity of the structure/area that is being treated or may be a portable unit. In the embodiment depicted in the Figures, the ionizer/air purifier 12 is positioned within the walls 20 of the building being treated. However, this should not be seen as to limit the scope of the present invention.

Ducting 14 may be coupled to the ionizer/air purifier 12. The ducting 14 allows the ionizer/air purifier 12 to facilitate the transfer of the ionized/purified air to all areas of the enclosed structure. As can be seen in FIG. 2, the ducting 14 may be used to facilitate the transfer of the ionized/purified air inside the different compartments of the wall 20. The ducting 14 will be placed either in the top or bottom of each wall section. Each wall section is defined wall joints 18. The ionized/purified air will flow inside the wall 20. This purifies the air inside the wall 20, and prevents, as well as removes, mold from forming in the interior of the wall 20. As may be seen in FIG. 3, the wall joints 18 may have a plurality of openings 16. The openings 16 help to facilitate the transfer of the ionized/purified air inside the different compartments of the wall 20 so less ducting 14 is required.

As stated above, the ducting 14 allows the ionizer/air purifier 12 to facilitate the transfer of the ionized/purified air to all areas of the enclosed structure. Thus, ducting 14 may be used to facilitate the transfer of the ionized/purified air outside of the interior of the walls 20 and inside the interior of different rooms of the enclosed structure.

While the invention has been particularly shown and described with reference to preferred embodiments thereof, it will be understood by those skilled in the art that the foregoing and other changes in form and details may be made therein without departing from the spirit and scope of the invention. For example, other devices and technologies, such as ultraviolet devices, may be used to remove the mold, mildew and bacteria from the interior of the walls. It should be noted that the listing of ultraviolet devices should not be seen as to limit the scope of the present invention.

1. A system for preventing mold from forming and for removing exiting mold, mildew, and other bacteria from an interior of walls and other areas in an enclosed area comprising:
at least one ionizer/air purifier unit for generating ionized air and activated oxygen; and
ducting coupled to the at least one ionizer/air purifier unit for transferring the ionized air to the interior of the walls and the other areas in the enclosed area.

2. A system for preventing mold from forming and for removing exiting mold, mildew, and other bacteria in accordance with claim 1 wherein the at least one ionizer/air purifier unit further draw in surrounding air and filters the air to purify the air.

3. A system for preventing mold from forming and for removing exiting mold, mildew, and other bacteria in accordance with claim 1 wherein the at least one ionizer/air purifier unit is located in the interior of the wall.

4. A system for preventing mold from forming and for removing exiting mold, mildew, and other bacteria in accordance with claim 1 further comprising a plurality of openings formed in wall supports to facilitate the air flow in the interior of the walls.

5. A system for preventing mold from forming and for removing exiting mold, mildew, and other bacteria from an interior of walls and other areas in an enclosed area comprising at least one ionizer/air purifier unit for generating ionized air and activated oxygen, the at least one ionizer/air purifier unit located internal to the walls, openings formed in wall supports to facilitate the air flow in the interior of the walls.

6. A system for preventing mold from forming and for removing exiting mold, mildew, and other bacteria in accordance with claim 5 further comprising ducting coupled to the at least one ionizer/air purifier unit for transferring the ionized air to the interior of the walls and the other areas in the enclosed area.

7. A system for preventing mold from forming and for removing exiting mold, mildew, and other bacteria in accordance with claim 5 wherein the at least one ionizer/air purifier unit further draw in surrounding air and filters the air to purify the air.

8. A system for preventing mold from forming and for removing exiting mold, mildew, and other bacteria from an interior of walls and other areas in an enclosed area comprising:
at least one ionizer/air purifier unit located in the interior of the walls for generating ionized air and activated oxygen and for drawing in surrounding air to filter the air to purify the air; and
ducting coupled to the at least one ionizer/air purifier unit for transferring the ionized air to the interior of the walls and the other areas in the enclosed area.

9. A system for preventing mold from forming and for removing exiting mold, mildew, and other bacteria in accordance with claim 8 further comprising a plurality of openings formed in wall supports to facilitate the air flow in the interior of the walls.
